(19) United States
(12) Patent Application Publication
(10) Pub. No.: US 2005/0284324 A1
(43) Pub. Date: Dec. 29, 2005

(54) Print defect displaying method and print defect displaying apparatus

(75) Inventors: Kazuki Fukui, Kyoto (JP); Satoru Kiyohara, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/137,480

(22) Filed: May 26, 2005

(30) Foreign Application Priority Data
Jun. 28, 2004 (JP) 2004-190041

(51) Int. Cl. B41F 1/54

(52) U.S. Cl. 101/484

(57) ABSTRACT

A print defect displaying method for displaying a defect on prints based on image data obtained by successively reading images from the prints. The method includes a first imaging step for obtaining first image data having a first resolution by reading an image from a first print, a defect detecting step for detecting a defect on the prints by comparing the image data obtained in the first imaging step and reference image data, a second imaging step for obtaining second image data having a second resolution higher than the first resolution, by reading an image from an area, including the defect detected in the defect detecting step, on a second print produced after the first print, and an enlarged image displaying step for displaying in enlargement the area including the defect based on the second image data.

### BACKGROUND OF THE INVENTION

1. Field of the Invention

This invention relates to a print defect displaying method and a print defect displaying apparatus.

2. Description of the Related Art

In order to perform proper printing with a printing machine, it is necessary to control ink feeding rates properly. For controlling the ink feeding rates, it has been conventional practice to measure densities of control strips with a densitometer and determine from density data whether the ink feeding rates are proper or not. However, the density data from the control strips alone is not necessarily sufficient for attaining a proper color tone and the like for a picture area.

For this reason, a tone control method is used which provides control data for controlling the ink feeding rates of a printing machine. The control data is produced by comparing a reference image, such as an image on reference paper, and images on actual prints.

The reference paper is also called proof paper, which serves as a reference indicating a color tone of finished prints to obtain proper prints. Image data of the reference paper can be obtained by reading the image of the reference paper with an image pickup device. Instead of obtaining the image data by reading the image of the reference paper, it is possible to use image data used in time of platemaking, or image data obtained by processing this image data.

The actual prints are also called sampling sheets which may be sheets of printing paper extracted by the operator from a discharge station of a printing machine at certain intervals during a printing operation. Image data of the actual prints may be obtained by reading images of the printing paper with the image pickup device. Alternatively, image data of the actual prints may be obtained by reading images of printing paper, immediately after the images are printed thereon, at an image pickup station disposed adjacent the discharge station of the printing machine.

Apart from the tone control described above, a print defect displaying method is carried out for checking whether proper printing is being performed or not. This is done by comparing a reference image and images on actual prints produced by a printing machine, and detecting and displaying a defect on the prints.

Japanese Unexamined Patent Publication No. 2002-36513, for example, discloses a print inspection apparatus for detecting a print defect by comparing a reference image read from a print serving as an inspection standard, and images to be inspected which are read from prints under inspection. The apparatus displays, along with the reference image, a defective image on which a defect has been detected, specifying a position of the defect in the defective image.

In time of reading images for detecting a defect on prints, it is difficult to use image data obtained by imaging the entire area of each print at high resolution because of limitations imposed by the capacity of image memory for storing image data, the data transfer rate and so on. In time of print defect inspection, therefore, the entire image of each print is read at a relatively low resolution. When the print is read at a relatively low resolution, although a defect of the print can be detected, it is difficult to determine particulars of the defect.

### SUMMARY OF THE INVENTION

The object of this invention, therefore, is to provide a print defect displaying method and a print defect displaying apparatus for displaying particulars of a defect on a print after detecting the defect.

The above object is fulfilled, according to this invention, by a print defect displaying method for displaying a defect on prints based on image data obtained by successively reading images from the prints, the method comprising a first imaging step for obtaining first image data having a first resolution by reading an image from a first print; a defect detecting step for detecting a defect on the prints by comparing the image data obtained in the first imaging step and reference image data; a second imaging step for obtaining second image data having a second resolution higher than the first resolution, by reading an image from an area, including the defect detected in the defect detecting step, on a second print produced after the first print; and an enlarged image displaying step for displaying in enlargement the area including the defect based on the second image data.

With this print defect displaying method, particulars of a defect on a print can be displayed after the defect is detected.

In a preferred embodiment, after executing the second imaging step and the enlarged image displaying step for a predetermined number of prints, operation returns from the enlarged image displaying step to the first imaging step to repeat a process.

In another embodiment, after executing the second imaging step and the enlarged image displaying step until an input is made by an operator, operation returns from the enlarged image displaying step to the first imaging step to repeat a process.

In another aspect of the invention, a print defect displaying method is provided for displaying a defect on prints based on image data obtained by successively reading images from the prints during a printing operation, the method comprising a first imaging step for obtaining first image data by reading an image from a first print with an imaging device capable of reading images from prints at a predetermined resolution D0; a defect detecting step for detecting a defect on the prints based on image data having a resolution D1 lower than the resolution D0, the image data of resolution D1 being obtained by thinning or averaging the first image data obtained in the first imaging step; a second imaging step for obtaining second image data of an area including the defect detected in the defect detecting step by reading an image from a second print produced after the first print, the second image data having a resolution D2 higher than the resolution D1; and an enlarged image displaying step for displaying in enlargement the area including the defect based on the second image data obtained in the second imaging step.

Other features and advantages of the invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a schematic view of a printing machine according to this invention;

FIG. 2 is a schematic view showing an image pickup station along with a paper discharge mechanism such as a paper discharge cylinder;

FIG. 3 is a block diagram showing a principal electrical structure of the printing machine;

FIG. 4 is a flow chart of a defect displaying operation;

FIG. 5 is a flow chart of the defect detecting operation;

FIG. 6 is an explanatory view schematically showing a display screen of a control panel; and

FIG. 7 is an explanatory view schematically showing the display screen of the control panel.

### DESCRIPTION OF THE PREFERRED EMBODIMENTS

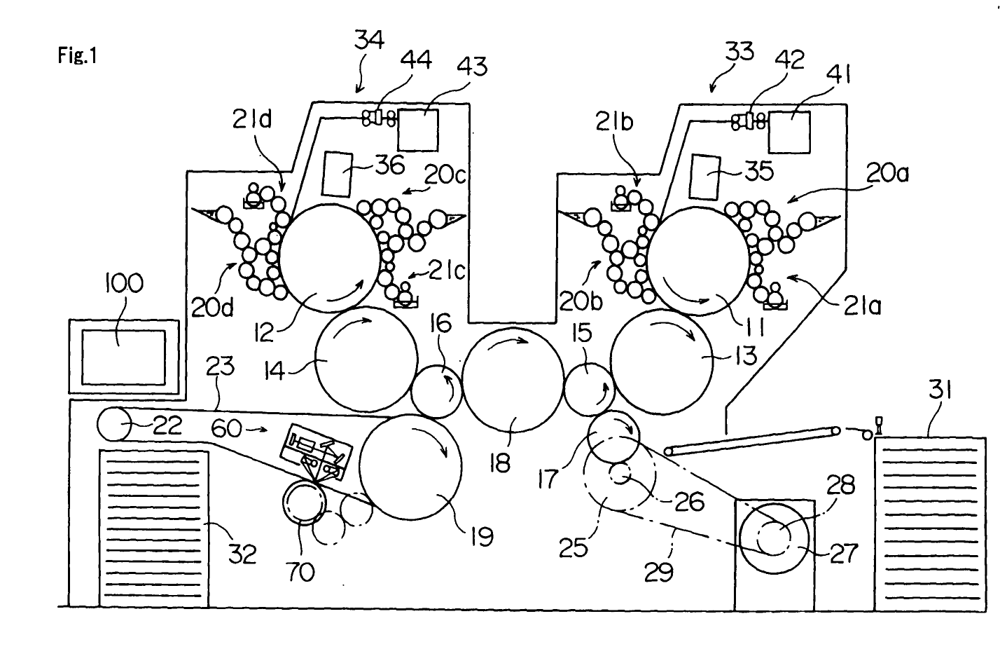

An embodiment of this invention will be described hereinafter with reference to the drawings. The construction of a printing machine according to this invention will be described first. FIG. 1 is a schematic view of the printing machine according to this invention.

This printing machine records images on blank plates mounted on first and second plate cylinders 11 and 12 in a prepress process, feeds inks to the plates having the images recorded thereon, and transfers the inks from the plates through first and second blanket cylinders 13 and 14 to printing paper held on first and second impression cylinders 15 and 16, thereby printing the images in four colors on the printing paper.

The printing machine has the first plate cylinder 11, the second plate cylinder 12, the first blanket cylinder 13 contactable with the first plate cylinder 11, the second blanket cylinder 14 contactable with the second plate cylinder 12, the first impression cylinder 15 contactable with the first blanket cylinder 13, and the second impression cylinder 16 contactable with the second blanket cylinder 14. The printing machine further includes a paper feed cylinder 17 for transferring printing paper supplied from a paper storage station 31 to the first impression cylinder 15, a transfer cylinder 18 for transferring the printing paper from the first impression cylinder 15 to the second impression cylinder 16, a paper discharge cylinder 19 with chains 23 wound thereon and extending to and wound on sprockets 22 for discharging printed paper from the second impression cylinder 16 to a paper discharge station 32, an image pickup station 60 for reading images and measuring densities of detecting patches printed on the printing paper, and a control panel 100 of the touch panel type.

Each of the first and second plate cylinders 11 and 12 is what is called a two-segmented cylinder for holding two printing plates peripherally thereof for printing in two different colors. The first and second blanket cylinders 13 and 14 have the same diameter as the first and second plate cylinders 11 and 12, and each has blanket surfaces for transferring images in two colors.

The first and second impression cylinders 15 and 16 movable into contact with the first and second blanket cylinders 13 and 14, respectively, have half the diameter of the first and second plate cylinders 11 and 12 and the first and second blanket cylinders 13 and 14. The first and second impression cylinders 15 and 16 have grippers, not shown, for holding and transporting the forward end of printing paper.

The paper feed cylinder 17 disposed adjacent the first impression cylinder 15 has the same diameter as the first and second impression cylinders 15 and 16. The paper feed cylinder 17 has a gripper, not shown, for holding and transporting, with each intermittent rotation of the feed cylinder 17, the forward end of each sheet of printing paper fed from the paper storage station 31. When the printing paper is transferred from the feed cylinder 17 to the first impression cylinder 15, the gripper of the first impression cylinder 15 holds the forward end of the printing paper which has been held by the gripper of the feed cylinder 17.

The transfer cylinder 18 disposed between the first impression cylinder 15 and second impression cylinder 16 has the same diameter as the first and second plate cylinders 11 and 12 and the first and second blanket cylinders 13 and 14. The transfer cylinder 18 has a gripper, not shown, for holding and transporting the forward end of the printing paper received from the first impression cylinder 15, and transferring the forward end of the printing paper to the gripper of the second impression cylinder 16.

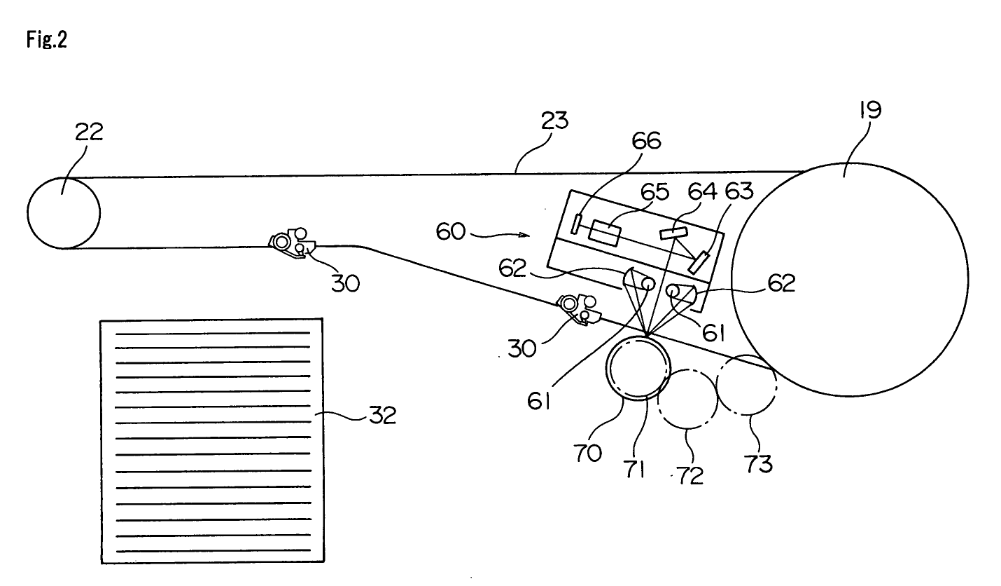

The paper discharge cylinder 19 disposed adjacent the second impression cylinder 16 has the same diameter as the first and second plate cylinders 11 and 12 and the first and second blanket cylinders 13 and 14. The discharge cylinder 19 has a pair of chains 23 wound around opposite ends thereof. The chains 23 are interconnected by coupling members, not shown, having a plurality of grippers 30 (FIG. 2). When the second impression cylinder 16 transfers the printing paper to the discharge cylinder 19, one of the grippers 30 on the discharge cylinder 17 holds the forward end of the printing paper having been held by the gripper of the second impression cylinder 16. With movement of the chains 23, the printing paper is transported to the paper discharge station 32 to be discharged thereon.

The paper feed cylinder 17 has a gear attached to an end thereof and connected to a gear 26 disposed coaxially with a driven pulley 25. A belt 29 is wound around and extends between the driven pulley 25 and a drive pulley 28 rotatable by a motor 27. Thus, the paper feed cylinder 17 is rotatable by drive of the motor 27. The first and second plate cylinders 11 and 12, first and second blanket cylinders 13 and 14, first and second impression cylinders 15 and 16, paper feed cylinder 17, transfer cylinder 18 and paper discharge cylinder 19 are coupled to one another by gears attached to ends thereof, respectively. Thus, by the drive of motor 27, the paper feed cylinder 17, first and second impression cylinders 15 and 16, paper discharge cylinder 19, first and second blanket cylinders 13 and 14, first and second plate cylinders 11 and 12 and transfer cylinder 18 are rotatable synchronously with one another.

The first plate cylinder 11 is surrounded by an ink feeder 20a for feeding an ink of black (K), for example, to a plate, an ink feeder 20b for feeding an ink of cyan (C), for example, to a plate, and dampening water feeders 21a and 21b for feeding dampening water to the plates. The second plate cylinder 12 is surrounded by an ink feeder 20c for feeding an ink of magenta (M), for example, to a plate, an ink feeder 20d for feeding an ink of yellow (Y), for example, to a plate, and dampening water feeders 21c and 21d for feeding dampening water to the plates.

Further, arranged around the first and second plate cylinders 11 and 12 are a plate feeder 33 for feeding plates to the peripheral surface of the first plate cylinder 11, a plate feeder 34 for feeding plates to the peripheral surface of the second plate cylinder 12, an image recorder 35 for recording images on the plates mounted peripherally of the first plate cylinder 11, and an image recorder 36 for recording images on the plates mounted peripherally of the second plate cylinder 12.

FIG. 2 is a schematic side view showing the image pickup station 60 for reading images and measuring densities of detecting patches printed on the printing paper, along with the paper discharge mechanism such as the paper discharge cylinder 19.

The pair of chains 23 are endlessly wound around the opposite ends of the paper discharge cylinder 19 and the pair of sprockets 22. As noted hereinbefore, the chains 23 are interconnected by coupling members, not shown, having a plurality of grippers 30 arranged thereon each for gripping the forward end of printing paper transported. FIG. 2 shows only two grippers 30, with the other grippers 30 omitted.

The pair of chains 23 have a length corresponding to a multiple of the circumference of first and second impression cylinders 15 and 16. The grippers 30 are arranged on the chains 23 at intervals each corresponding to the circumference of first and second impression cylinders 15 and 16. Each gripper 30 is opened and closed by a cam mechanism, not shown, synchronously with the gripper on the paper discharge cylinder 19. Thus, each gripper 30 receives the printing paper from the paper discharge cylinder 19, transports the printing paper with rotation of the chains 23, and is then opened by the cam mechanism, not shown, to discharge the paper on the paper discharge station 32.

The printing paper is transported with only the forward end thereof held by one of the grippers 30, the rear end of printing paper not being fixed. Consequently, the printing paper could flap during transport, which impairs operations, to be described hereinafter, of the image pickup station 60 to read images and measure densities of the detecting patches. To avoid such an inconvenience, this printing machine provides a suction roller 70 disposed upstream of the paper discharge station 32 for stabilizing the printing paper transported.

The suction roller 70 is in the form of a hollow roller having a surface defining minute suction bores, with the hollow interior thereof connected to a vacuum pump not shown. The suction roller 70 has a gear 71 attached to an end thereof. The gear 71 is connected through idler gears 72 and 73 to the gear attached to an end of the paper discharge cylinder 19. Consequently, the suction roller 43 is driven to rotate in a matching relationship with a moving speed of the grippers 30. Thus, the printing paper is sucked to the surface of the suction roller 70, thereby being held against flapping when passing over the suction roller 70. In place of the suction roller 70, a suction plate may be used to suck the printing paper two-dimensionally.

The above image pickup station 60 includes a pair of linear light sources 61 extending parallel to the suction roller 70 for illuminating the printing paper on the suction roller 70, a pair of condensing plates 62, reflecting mirrors 63 and 64, a condensing lens 65 and a CCD line sensor 66. The printing paper transported by the paper discharge mechanism including the paper discharge cylinder 19 and chains 23 is illuminated by the pair of linear light sources 61, and photographed by the CCD line sensor 66. The image of the printing paper and density data are displayed on the control panel 100 of the touch panel type.

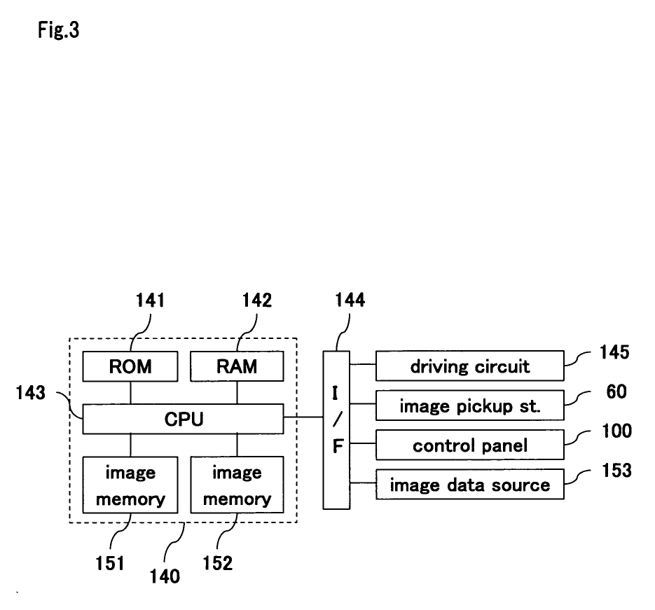

FIG. 3 is a block diagram showing a principal electrical structure of the printing machine. The machine includes a control unit 140 having a ROM 141 for storing operating programs necessary for controlling the machine, a RAM 142 for temporarily storing data and the like during a control operation, and a CPU 143 for performing logic operations. The control unit 140 has a driving circuit 145 connected thereto through an interface 144, for generating driving signals for driving the ink feeders 20, dampening water feeders 21, image recorders 35 and 36, and contact mechanisms for moving the first and second blanket cylinders 13 and 14. The printing machine is controlled by the control unit 140 to perform prepress and printing operations described hereinafter.

The control unit 140 includes a first and a second image memories 151 and 152 described hereinafter. The control unit 140 is connected also to the image pickup station 60 and control panel 100 through the interface 144. Further, the control unit 140 is connected also to an image data source 153 described hereinafter, such as an image processing apparatus constituting a stage preceding this printing machine.

In the printing machine having the above construction, a printing plate stock drawn from a supply cassette 41 of the plate feeder 33 is cut to a predetermined size by a cutter 42. The forward end of each plate in cut sheet form is guided by guide rollers and guide members, not shown, and is clamped by clamps of the first plate cylinder 11. Then, the first plate cylinder 11 is driven by a motor, not shown, to rotate at low speed, whereby the plate is wrapped around the peripheral surface of the first plate cylinder 11. The rear end of the plate is clamped by other clamps of the first plate cylinder 11. While, in this state, the first plate cylinder 11 is rotated at low speed, the image recorder 35 irradiates the surface of the plate mounted peripherally of the first plate cylinder 11 with a modulated laser beam for recording an image thereon.

Similarly, a printing plate stock drawn from a supply cassette 43 of the plate feeder 34 is cut to the predetermined size by a cutter 44. The forward end of each plate in cut sheet form is guided by guide rollers and guide members, not shown, and is clamped by clamps of the second plate cylinder 12. Then, the second plate cylinder 12 is driven by a motor, not shown, to rotate at low speed, whereby the plate is wrapped around the peripheral surface of the second plate cylinder 12. The rear end of the plate is clamped by other clamps of the second plate cylinder 12. While, in this state, the second plate cylinder 12 is rotated at low speed, the image recorder 36 irradiates the surface of the plate mounted peripherally of the second plate cylinder 12 with a modulated laser beam for recording an image thereon.

The first plate cylinder 11 has, mounted peripherally thereof, a plate for printing in black ink and a plate for printing in cyan ink. The two plates are arranged in evenly separated positions (i.e. in positions separated from each other by 180 degrees). The image recorder 35 records images on these plates. Similarly, the second plate cylinder 12 has, mounted peripherally thereof, a plate for printing in magenta ink and a plate for printing in yellow ink. The two plates also are arranged in evenly separated positions, and the image recorder 36 records images on these plates, to complete a prepress process.

The prepress process is followed by a printing process for printing the printing paper with the plates mounted on the first and second plate cylinders 11 and 12. This printing process is carried out as follows.

First, each dampening water feeder 21 and each ink feeder 20 are placed in contact with only a corresponding one of the plates mounted on the first and second plate cylinders 11 and 12. Consequently, dampening water and inks are fed to the plates from the corresponding water feeders 21 and ink feeders 20, respectively. These inks are transferred from the plates to the corresponding regions of the first and second blanket cylinders 13 and 14, respectively.

Then, the printing paper is fed to the paper feed cylinder 17. The printing paper is subsequently passed from the paper feed cylinder 17 to the first impression cylinder 15. The impression cylinder 15 having received the printing paper continues to rotate. Since the first impression cylinder 15 has half the diameter of the first plate cylinder 11 and the first blanket cylinder 13, the black ink is transferred to the printing paper wrapped around the first impression cylinder 15 in its first rotation, and the cyan ink in its second rotation.

After the first impression cylinder 15 makes two rotations, the printing paper is passed from the first impression cylinder 15 to the second impression cylinder 16 through the transfer cylinder 18. The second impression cylinder 16 having received the printing paper continues to rotate. Since the second impression cylinder 16 has half the diameter of the second plate cylinder 12 and the second blanket cylinder 14, the magenta ink is transferred to the printing paper wrapped around the second impression cylinder 16 in its first rotation, and the yellow ink in its second rotation.

The forward end of the printing paper printed in the four colors in this way is passed from the second impression cylinder 16 to the paper discharge cylinder 19. The printing paper is transported by the pair of chains 23 toward the paper discharge station 32 to be discharged thereon. At this time, the printing paper being transported is illuminated by the pair of linear light sources 61, and is photographed by the CCD line sensor 66. The photographed image is displayed on the control panel 100.

In the printing machine in this embodiment, image data obtained by reading images is used also in controlling feeding rates of the inks and dampening water. Specifically, the image itself and the detecting patches are read from prints, and image data thereby obtained is used to calculate color densities or color values of the YMCK colors in a pertinent area. The color densities or color values are then compared with predetermined values, e.g. reference color densities or color values made available in advance, to adjust the feeding rates of the inks and dampening water. Such methods of adjusting ink and dampening water feeding rates are disclosed, for example, in Japanese Unexamined Patent Publications Nos. 2001-253054 and [2001-355950, and will not particularly be described herein.

After the printing process, the printing paper printed is discharged. The first and second blanket cylinders 13 and 14 are cleaned by a blanket cylinder cleaning device, not shown, to complete the printing process.

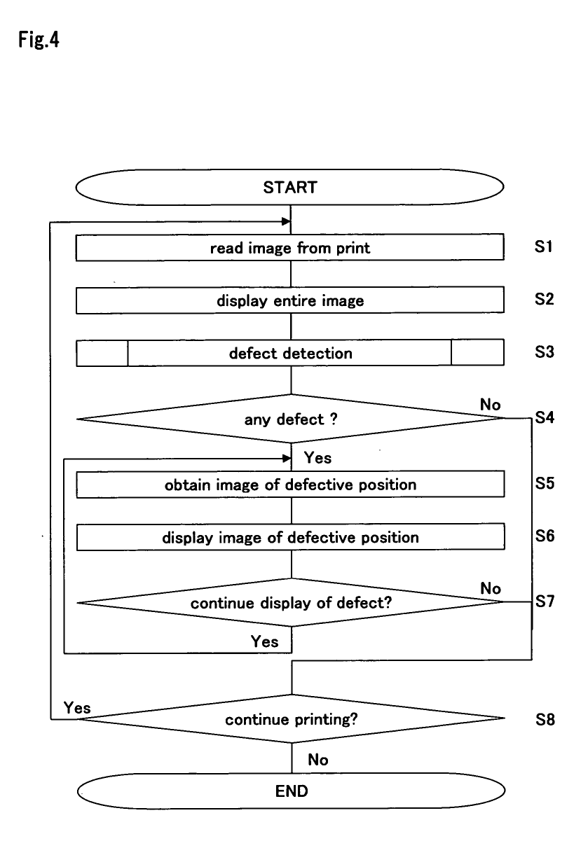

A defect displaying method used with the above printing machine for detecting and displaying a defect on prints will be described next. FIG. 4 is a flow chart of a defect displaying operation.

First, a first actual print is photographed at the image pickup station 60 to read its image data (step S1). The image data obtained from the actual print is stored as first image data in the second image memory 152 shown in FIG. 3.

When reading the image of an actual print at the image pickup station 60, it is difficult to obtain data from the entire area of the print at high resolution because of limitations imposed by the capacity of the second image memory 152, the data transfer rate and so on. Particularly when detecting a defect in real time while printing the entire image of a print, high resolution data requires too long a processing time to serve the purpose. For this reason, the entire image of a print is read at a relatively low, first resolution D1. In order to read the entire image of a print at the relatively low, first resolution D1, an imaging operation may be carried out by using every several CCD elements in the CCD line sensor 66, for example.

In this embodiment, for example, the CCD line sensor 66 has an optical system for scanning at a resolution D0=400 dpi transversely of the printing direction. When scanning images with this CCD line sensor 66, image data will be obtained at the low resolution D1=100 dpi by obtaining data from every four CCD elements. Such thinning of CCD pixels may be carried out when obtaining image data from the CCD elements. Alternatively, image data obtained at 400 dpi may be thinned to create image data at 100 dpi. Instead of thinning down to every four pixels, an average value of every four pixels may be used. As long as there is no problem with processing speed, another known resolution converting algorithms may be used. On the other hand, resolution in the printing direction may be changed by setting a CCD reading sampling according to a printing speed (print transport speed). However, there is no need to match the resolution in the printing direction with the resolution in the transverse direction. The above numerical values are given only by way of example, and the resolutions D0 and D1 may be determined appropriately according to the printing speed or the performance of the control device.

The first image memory 151 shown in FIG. 3 already stores image data used as reference for detecting a defect. The image data used as reference is PPF data, for example, which is data supplied from the image data source 153 shown in FIG. 3. Alternatively, the image data used as reference may be image data obtained by reading an image from reference paper, for example. The reference paper is also called proof paper, which serves as a reference indicating a color tone of finished prints to obtain proper prints. It is also possible to use image data used in time of platemaking, or image data obtained by processing this image data.

Next, the image of the entire print is displayed on the control panel 100 (step S2).

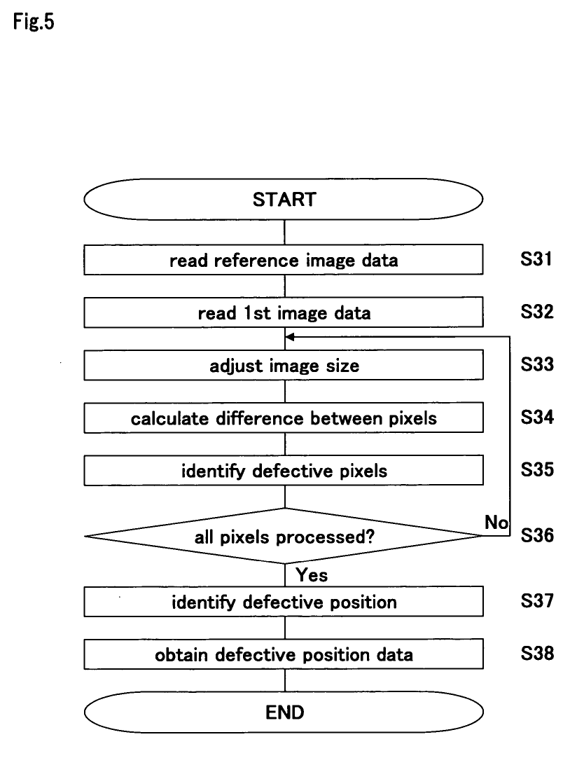

FIG. 5 is an explanatory view schematically showing a display screen 200 of the control panel 100.

This display screen 200 includes a main display section 201 and sub-display sections 202 and 203. The image of the entire print is displayed in the main display section 201. When a defect is detected in a defect detecting step described hereinafter, a defective position 205 also is displayed in the main display section 201.

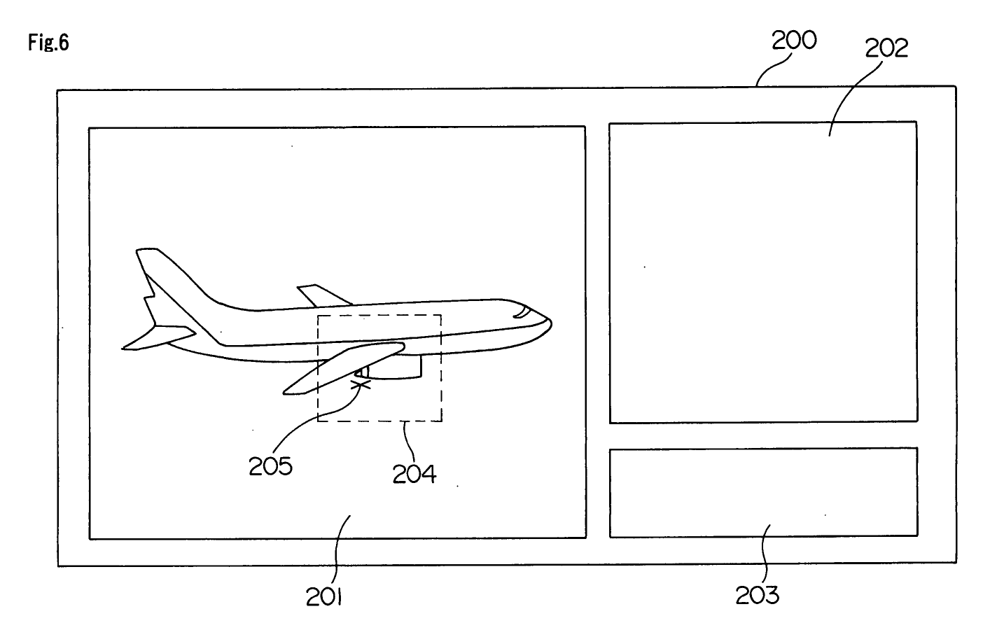

Next, any defect in the image of the entire print is detected (step S3). This defect detecting operation is carried out according to the subroutine shown in FIG. 6.

In order to detect a defect, the image data serving as reference is first read from the first image memory 151 (step S31). Then, the first image data is read from the second image memory 152 (step S32).

Next, the image data serving as reference and the first image data obtained by reading the image from the print at the image pickup station 60 are brought into agreement in size (step S33). That is, when a difference in size such as resolution or number of pixels exists between these image data, the image data are adjusted to the same size. A technique of such size adjustment is described in Japanese Patent Application No. 2002-205117, for example.

Next, a difference between pixels is calculated for each pixel pair (step S34). In this case, a difference between pixels is calculated after positioning the reference image data and first image data on the basis of register marks or particular pixels. Techniques for positioning image data are described in Japanese Patent Applications Nos. 2002-205117 and 2003-166335, for example.

Next, defective pixels are identified based on the difference calculation described above (step S35). In this case, for example, defective pixels are those for which a sum total of absolute values of differences in the RGB or YMCK color components or color differences in a predetermined color system exceeds a threshold.

The above operation is repeated for all pixels (step S36). As described above, the first image data has the relatively low, first resolution Dl. Thus, the above operation may be repeated for all pixels in a relatively short processing time.

When the above operation is completed for all pixels, a defective part is identified (step S37). In this case, for example, a defective part identified as such has more than a predetermined number of defective pixels in continuation. The defect detecting operation is ended after obtaining data indicating the defective position 205 which is a position of the defective part identified (step S38).

Referring to FIG. 4 again, when no defect is found in step S3 (step S4), whether to continue printing or not is determined (step S8). When printing is to be continued, the operation returns to step S1 to continue the process. When printing is to be discontinued, the process is ended.

On the other hand, when a defect is found in step S3, an image is read at the image pickup station 60 from an area around the defective position on a second print made after the first print, and its image data is obtained as second image data (step S5). This second image data is stored in the second image memory 152 shown in FIG. 3.

In this case, the image of the area around the defective position 205 on the print is read at a second resolution D2 higher than the relatively low, first resolution D1. In order to read the image from the print at the relatively high, second resolution D2, an imaging operation may be carried out by using all the CCD elements in the CCD line sensor 66, for example.

That is, in this embodiment, the imaging at the second resolution D2 is performed at the resolution D0=400 dpi, which is a normal use of the CCD elements. Image data is obtained only for a part including the area where the defect on the print is detected. Thus, although high in resolution, the image data may be maintained small in amount. This avoids the problem of image data transfer time or image processing time being too long. Although D2=D0 in this example, a required resolution may be set appropriately in a range of D2>D1.

Where the imaging is performed at the image pickup station 60 at predetermined intervals (e.g. at intervals of several to ten-odd prints), several to ten-odd prints are normally made between the first print and second print. However, the defect appearing on the first print tends to continue appearing in the same place on subsequent prints. In this invention, therefore, the images of the first and second prints are used to detect a defect and display it in enlargement.

Next, a defect image is displayed in enlargement by using the second image data obtained at the second resolution D2 (step S6). In this case, an area 204 including the defective position 205 shown in FIG. 6 is displayed in enlargement.

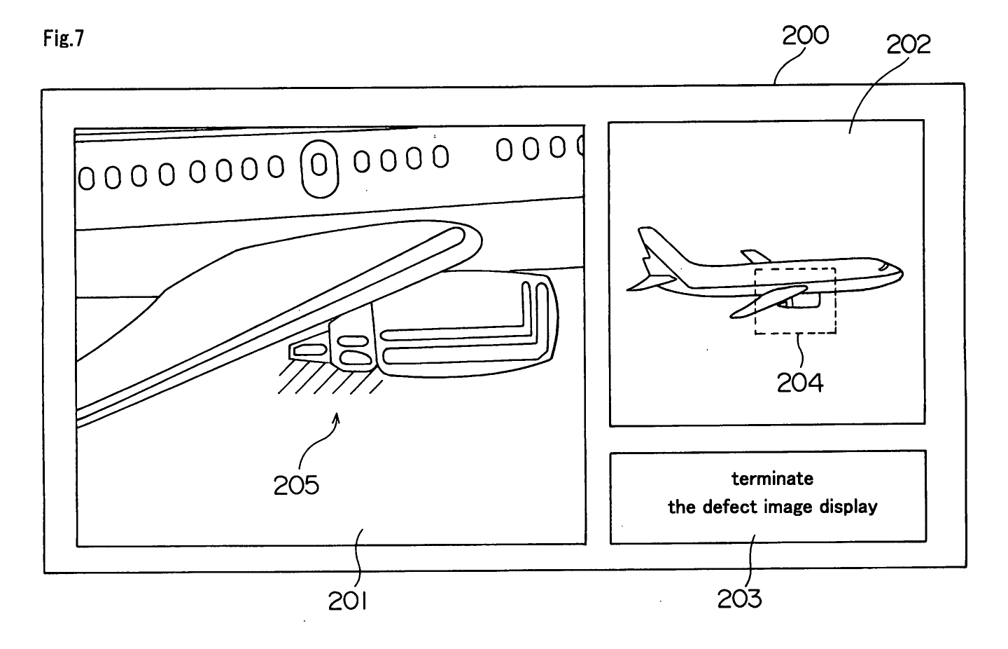

FIG. 7 is an explanatory view schematically showing the display screen 200 of the control panel 100 in step S6.

The area 204 including the defective position 205 shown in FIG. 6 is displayed as enlarged in the main display section 201 of the display screen 200. The area 204, displayed in enlargement, where the defect shown in FIG. 6 is detected includes also the defective position 205 displayed in enlargement. As described above, the area around the defective position 205 on the print is imaged at the relatively high, second resolution D2. Thus, the defective position 205 also is displayed in enlargement and with high precision. This allows a state of the defect to be recognized reliably.

At this time, the image of the entire print may be displayed in reduction in the sub-display section 202 of the display screen 200. This allows the operator to check simultaneously the image of the entire print and the image of the area where the defect is detected. At this time, the sub-display section 203 of the display screen 200 functions as a key area for touch input to be made for terminating the defect image display.

Referring to FIG. 4 again, whether it is necessary to continue the defect image display is determined (step S7). This determination is made in one of the following modes.

In the first mode, the defective position imaging step (step S5) and the enlarged defect image displaying step (step S6) are repeatedly executed for the number of prints set beforehand. Then it is determined that the defect image display is no longer necessary, the enlarged display of the defect image is ended, and the operation moves to step S8.

In the second mode, the defective position imaging step (step S5) and the enlarged defect image displaying step (step S6) are repeated until an input is made by the operator. The operator checks the particulars of the defect, and may determine that the defect image display is no longer necessary. Then, the operator presses on the sub-display section 203 functioning as a key area of the display screen 200. As a result, the enlarged display of the defect image is ended, and the operation moves to step S8.

Then, as described hereinbefore, whether to continue printing or not is determined (step S8). To continue printing, the operation returns to step S1 to continue the process. To discontinue printing, the process is ended.

In the embodiment described above, an imaging operation is carried out by using only every several CCD elements in the CCD line sensor 66 in order to read the image of a print at the relatively low, first resolution D1. However, this invention is not limited to such a reading mode.

For example, magnification of the optical system may be varied for obtaining the image of an entire print and for obtaining the image of a defective position 205, thereby obtaining image data of different resolutions.

In this case, the CCD line sensor 66 may, for example, be constructed movable transversely of the printing direction according to a defective position. In addition, an enlarged image may be read from a limited area by varying the magnification of the optical system in zoom fashion.

Other modifications of the embodiment are set out hereunder by way of example. In the foregoing embodiment, the display screen 200 is switchable to display the image of an entire print and the image including a defect as enlarged. Instead, the hardware may be extended to include an additional display device or display window to display the two images in parallel. The image data with a defect in enlarged form may be stored in a hard disk or the like, so that the defect may be checked as desired, or may be outputted as a print with an inkjet printer, for example. Where a hardware extension is acceptable, two or more image pickup stations 60 may be installed to read an entire image and an enlarged image at the same time.

This invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Application No. 2004-190041 filed in the Japanese Patent Office on Jun. 28, 2004, the entire disclosure of which is incorporated herein by reference.

1. A print defect displaying method for displaying a defect on prints based on image data obtained by successively reading images from the prints, said method comprising:
a first imaging step for obtaining first image data having a first resolution by reading an image from a first print;
a defect detecting step for detecting a defect on the prints by comparing the image data obtained in said first imaging step and reference image data;
a second imaging step for obtaining second image data having a second resolution higher than said first resolution, by reading an image from an area, including said defect detected in said defect detecting step, on a second print produced after said first print; and
an enlarged image displaying step for displaying in enlargement said area including said defect based on said second image data.

2. A print defect displaying method as defined in claim 1, wherein, after executing said second imaging step and said enlarged image displaying step for a predetermined number of prints, operation returns from said enlarged image displaying step to said first imaging step to repeat a process.

3. A print defect displaying method as defined in claim 1, wherein, after executing said second imaging step and said enlarged image displaying step until an input is made by an operator, operation returns from said enlarged image displaying step to said first imaging step to repeat a process.

4. A print defect displaying method as defined in claim 1, wherein said enlarged image displaying step is executed to display, along with said area including said defect, the image of said first print in its entirety based on said first image data.

5. A print defect displaying method for displaying a defect on prints based on image data obtained by successively reading images from the prints during a printing operation, said method comprising:
a first imaging step for obtaining first image data by reading an image from a first print with an imaging device capable of reading images from prints at a predetermined resolution D0;
a defect detecting step for detecting a defect on the prints based on image data having a resolution D1 lower than said resolution D0, said image data of resolution D1 being obtained by thinning or averaging said first image data obtained in said first imaging step;
a second imaging step for obtaining second image data of an area including said defect detected in said defect detecting step by reading an image from a second print produced after said first print, said second image data having a resolution D2 higher than said resolution D1; and
an enlarged image displaying step for displaying in enlargement said area including said defect based on said second image data obtained in said second imaging step.

6. A print defect displaying method as defined in claim 5, wherein, after executing said second imaging step and said enlarged image displaying step for a predetermined number of prints, operation returns from said enlarged image displaying step to said first imaging step to repeat a process.

7. A print defect displaying method as defined in claim 5, wherein, after executing said second imaging step and said enlarged image displaying step until an input is made by an operator, operation returns from said enlarged image displaying step to said first imaging step to repeat a process.

8. A print defect displaying method as defined in claim 5, wherein said enlarged image displaying step is executed to display, along with said area including said defect, the image of said first print in its entirety based on said first image data.

9. A print defect displaying apparatus for displaying a defect on prints based on image data obtained by successively reading images from the prints, said apparatus comprising:
imaging means for reading images from prints;
an image memory for storing reference image data;
defect detecting means for detecting a defect on the prints by comparing image data having a first resolution, obtained by reading an image of a first print with said imaging means, and the reference image data stored in said image memory; and
image display means for displaying in enlargement an area including said defect based on second image data having a second resolution higher than said first resolution, said second image data being obtained by reading, with said imaging means, an image of said area including said defect on a second print produced after said first print.

10. A print defect displaying apparatus as defined in claim 9, wherein said image display means is arranged to display, along with said area including said defect, the image of said first print in its entirety based on said first image data.

11. A print defect displaying apparatus for displaying a defect on prints based on image data obtained by successively reading images from the prints during a printing operation, said apparatus comprising:
imaging means for reading images from prints;
an image memory for storing reference image data;
defect detecting means for obtaining first image data having a low, first resolution D1 by thinning or averaging image data obtained by reading an image of a first print with said imaging means, and detecting a defect on the prints by comparing said first image data and said reference image data stored in said image memory; and
image display means for displaying in enlargement an area including said defect based on second image data obtained by reading at a second resolution D2 higher than said first resolution D1, with said imaging means, an image of said area including said defect on a second print produced after said first print.

12. A print defect displaying apparatus as defined in claim 11, wherein said image display means is arranged to display, along with said area including said defect, the image of said first print in its entirety based on said first image data.
